(19) United States
(12) Patent Application Publication
(10) Pub. No.: US 2020/0134039 A1
(43) Pub. Date: Apr. 30, 2020

(54) REAL-TIME ADAPTATION OF TEXTUAL CONTENT DEPENDENT ON USER UNDERSTANDING

(71) Applicant: international Business Machines Corporation, Armonk, NY (US)

(72) Inventors: Nebula Alam, MELBOURNE (AU); Shail Pervin, MELBOURNE (AU); Simon Harris, MELBOURNE (AU); Andrew Rawlinson, MELBOURNE (AU); Wanita Sherchan, MELBOURNE (AU)

(21) Appl. No.: 16/173,058

(22) Filed: Oct. 29, 2018

(51) Int. Cl. G06F 17/30; G06F 17/22; G06F 17/28

(52) U.S. Cl. CPC G06F 17/3071; G06F 17/30713; G06F 17/28; G06F 17/30011; G06F 17/2276; G06F 17/30648

(57) ABSTRACT

A textual content adaption method, system, and computer program product, include receiving a corpus of content, segmenting the content into sections, determining a classification for each section by determining an audience and an expertise level for the section, determining a baseline for a user, modifying a portion of content from the corpus based on the classification of the sections included in the portion of content and based on the baseline of the user, and providing the modified portion of content to the user.

### BACKGROUND

The present invention relates generally to a textual content adaption method, and more particularly, but not by way of limitation, to a system, method, and recording medium for using information of a user's capability and subject understanding to modify the content of a single corpus of learning material for better and targeted delivery of content.

When presenting a single content to different users, the content may need on the fly modification or personalization based on the user's characteristics. For example, when Wikipedia® text on “Democracy” is viewed by ten-year olds versus thirty-year old PhD students, the complexity of the content may need adaptation (e.g., like expansion of complex terms and removing advanced contents for the ten-year old) based on the reader.

Conventional techniques deliver content without altering the content based on a demographic of the user. For example, some conventional techniques maintain a repository of different versions of similar content and decide which one to present based on the audience demographics.

However, the conventional techniques do not modify the content of a single corpus of text in real-time by analyzing the user's demographics (e.g., age, educational background, subject understanding, etc.) as well as the real-time understanding.

Thus, there is a need in the art to segment digital textual content and classify each section of the content based on the simplicity and complexity of the digital textual content.

### SUMMARY

In an exemplary embodiment, the present invention can provide a computer-implemented textual content adaption method, the method including receiving a corpus of content, segmenting the content into sections, determining a classification for each section by determining an audience and an expertise level for the section, determining a baseline for a user, modifying a portion of content from the corpus based on the classification of the sections included in the portion of content and based on the baseline of the user baseline, and providing the modified portion of content to the user.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which

FIG. 1 exemplarily shows a high-level flow chart for a textual content adaption method 100.

FIG. 2 depicts a cloud computing node 10 according to an embodiment of the present invention;

FIG. 3 depicts a cloud computing environment 50 according to an embodiment of the present invention; and

FIG. 4 depicts abstraction model layers according to an embodiment of the present invention.

### DETAILED DESCRIPTION

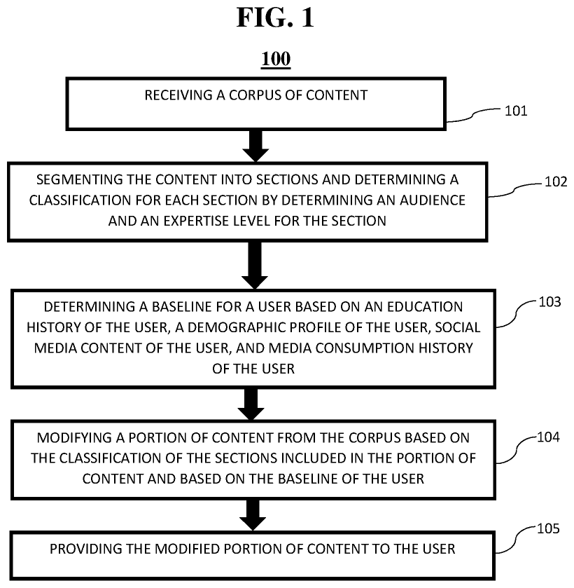

The invention will now be described with reference to FIG. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the example depicted in FIG. 1, the textual content adaption method 100 includes various steps to modify the content of a single corpus of learning material for better and targeted delivery of content. That is, the invention can segment digital textual content and classify each section of the content based on the simplicity and complexity of the digital textual content.

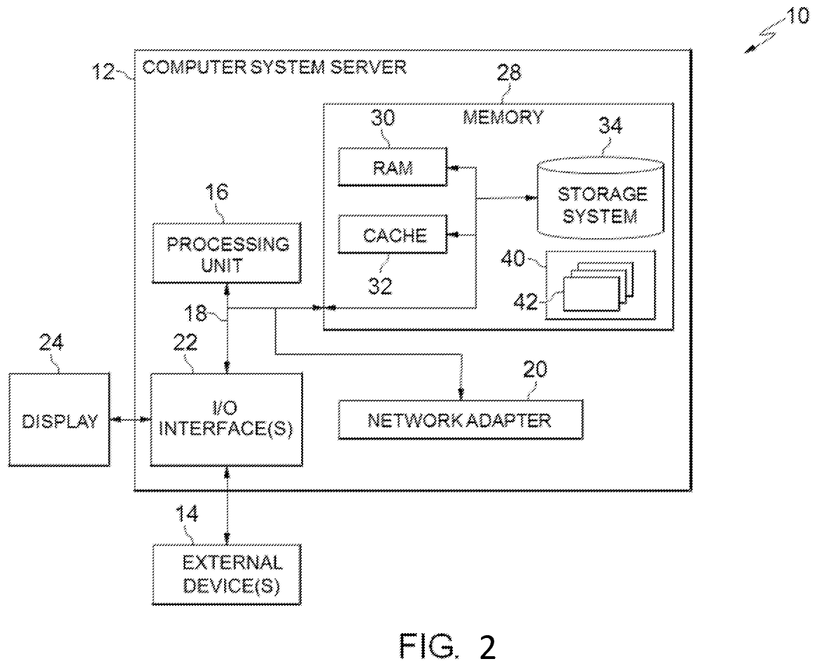

As shown in at least FIG. 2, one or more computers of a computer system 12 according to an embodiment of the present invention can include a memory 28 having instructions stored in a storage system to perform the steps of FIG. 1.

Thus, the textual content adaption method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

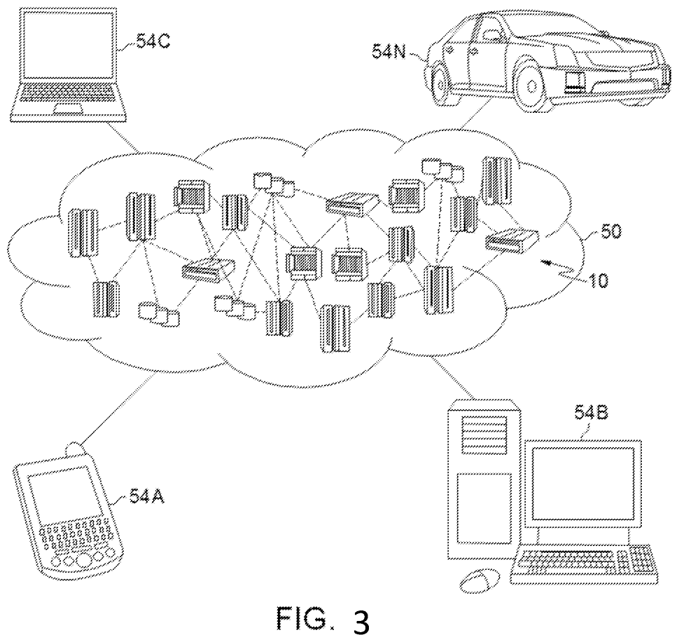

Although one or more embodiments (see e.g., FIGS. 2-4) may be implemented in a cloud environment 50 (see e.g., FIG. 3), it is nonetheless understood that the present invention can be implemented outside of the cloud environment.

With reference generally to FIG. 1, the invention uses information of the user's capability (and demographics) and subject understanding to modify the content of a single corpus of learning material for better and targeted delivery of content. The modification history is then saved with the original corpus, thereby creating a dynamic super corpus. One advantage of the invention is that the content creator needs only to create one corpus of content that can be presented by the system to a wide range of users, thereby saving resources required to create the content. Targeted educational materials also means there will be better learning by the user.

In one embodiment, the invention digests a single corpus of content covering a wide range of ‘education’ levels created by the content creator. Machine learning is used to classify sections of content by demographics (age, education level, ethnicity, nationality, profession, etc.) and a concept complexity.

It is noted that a single corpus refers to the original textual entry of the data. That is, the invention does not include multiple versions of the same original textural entry of data digested into the invention but instead only digests a single version (e.g., a single corpus) and modifies the text according to the baseline user understanding (as discussed below).

A module gathers and stores a baseline user understanding, using a user's learning history, a user's demographic profile, mined social media content, media consumption (e.g., television, Netflix®, movies, etc.) habits.

Another module compares the baseline user understanding to the classified content complexity and modifies the content in real time, such that the content is appropriate for that specific user.

For example, in one embodiment, the invention can digest the first paragraph on ‘Democracy’ from Wikipedia®:
“Democracy (Greek: δημoκρατiα dēmokratía, literally “rule of the people”), in modern usage, is a system of government in which the citizens exercise power directly or elect representatives from among themselves to form a governing body, such as a parliament. Democracy is sometimes referred to as “rule of the majority”. Democracy is a system of processing conflicts in which outcomes depend on what participants do, but no single force controls what occurs and its outcomes.”

It is noted that the above is an example of a single corpus of data. Prior art techniques digest multiple versions of the above and merely distribute the version that best fits the user. However, the invention only digests one version of the text (i.e., the original version) and the invention can use several techniques used to adapt the content based on the user.

In one embodiment, the invention can use a summarization technique that, depending on concept classification, advanced topics are withheld and summarized for learners below that level and basic concepts are summarized and skipped for advanced learners. In one example, a ten year old will be presented with “Democracy is sometimes referred to as “rule of the majority””, while older learners would get the full text.

The invention can utilize another technique known as “expansion” in which for concepts classified as “advanced” or concepts which the user has no prior knowledge are expanded by searching the web or the content database and adding extra learning material to explain those concepts. These new contents are added to the existing corpus to create a dynamic corpus.

In one embodiment, simplification can be used in which, for users with lower language capabilities and understanding, the content is modified to be presented using simpler language. The sentences in the content are classified using machine learning for their grammatical complexity, which is then compared to the user's capabilities. Depending on that comparison, complex sentences may be broken down to simpler and smaller sentences, complex words may be replaced with synonyms, acronyms and abbreviations may be expanded and business terms are replaced with layman's terms.

Thus, the invention modifies the version digested into the invention as a single corpus by changing the words (and/or sentence structure) to convey the same meaning to the user with either advancing/simplifying the delivery.

A module continuously monitors user feedback using a simple button for the user to click (e.g., ‘I understand’/‘I don't understand’). The invention also pulls data from sensors on the user to gauge user understanding in real-time.

For example, eye gaze tracking technology can be used to track a user's pace of reading the content, thereby to determine their understanding. Or, facial recognition technology can be used to analyze facial expressions to determine an ease of which the user is understanding the content. This information is then used to update the baseline understanding.

The user's learning history is updated according to feedback. Future content will be adapted according to the users ‘new’ understanding of the topic.

With reference to FIG. 1, the method 100 provides a real-time adaptation of textual content based on user understanding.

In step 101, a corpus of content is received. And, in step 102, the content is segmented into sections of which a classification for each section is determined by determining an audience and an expertise level of the section.

In step 103, a baseline is determined for a user based on the user's educational history, a demographic profile (e.g., age, profession, etc.), social media content, and media (e.g., TV, movies, etc.) consumption history. The user's baseline is continually adjusted based on changes to the user's information and further based on user feedback (e.g., feedback indicating whether the user understands the content).

In other words, the invention determines a minimum level of content that the user is likely to understand and then adjusts the baseline accordingly. For example, a baseline for a sixth grade student may include determining their baseline reading level (e.g., sixth-grade reading level) and then adjusting the content (described later) to a sixth-grade reading level (e.g., adjusting to their baseline).

The baseline is continuously updated based on the user's interaction with the invention (e.g., feedback). For example, if the sixth-grade user continuously understands the sixth grade reading content, the user may be increased to a seventh-grade reading level and content will be modified to a seventh-grade reading level.

In step 104, a portion of the content from the corpus is modified based on the classification of the sections included in the portion of content and further based on the user's baseline, and in step 105 the modified portion is provided to the user.

Thus, the invention can improve upon the prior techniques by segmenting the digital textual content and classifying each section of the content based on the simplicity and complexity of the digital textual content.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools textual content adaptioned by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and textual content adaptions a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 2, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 3 are intended to be illustrative only and that computing nodes 10 and cloud computing environment 50 can communicate with any type of computerized circuit over any type of network and/or network addressable connection (e.g., using a web browser).

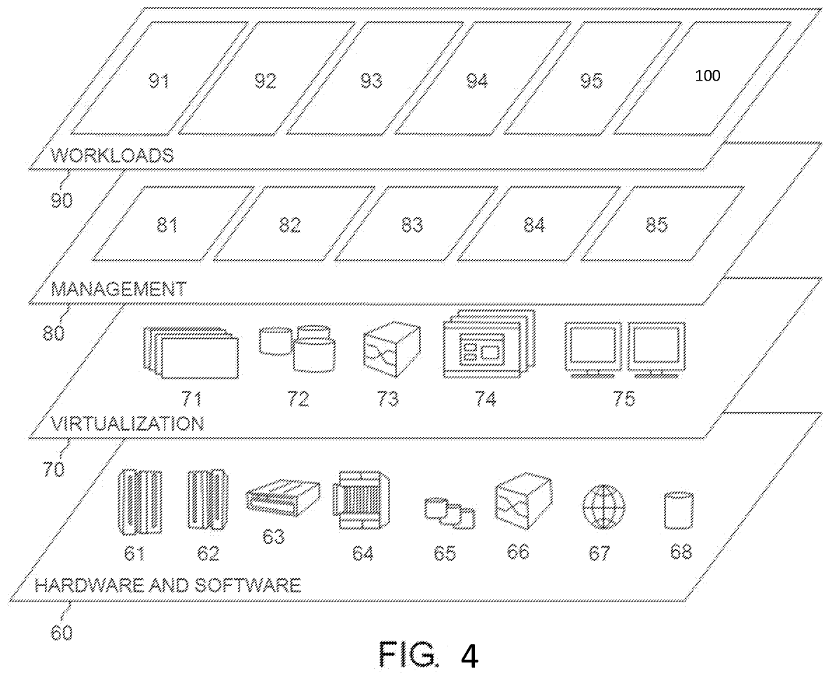

Referring now to FIG. 4, an exemplary set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the textual content adaption method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented textual content adaption method, the method comprising:
receiving a corpus of content;
segmenting the content into sections;
determining a classification for each section by determining an audience and an expertise level for the section;
determining a baseline for a user,
modifying a portion of the content from the corpus based on the classification of the sections included in the portion of the content and based on the baseline of the user; and
providing the modified portion of the content to the user.

2. The computer-implemented method of claim 1, wherein the modifying modifies the portion of the content by one of:
summarization;
expansion;
simplification; and
a substitution of a first section for a second section.

3. The computer-implemented method of claim 1, wherein the baseline of the user is continually adjusted based on changes to the baseline for the user and on user feedback indicating an understanding of the content.

4. The computer-implemented method of claim 1, wherein the baseline of the user is based on at least one of:
an education of the user;
a demographic of the user,
social media content produced by the user; and
a media consumption history of the user.

5. The computer-implemented method of claim 1, wherein the baseline of the user is based on a combination of each of:
an education of the user,
a demographic of the user,
social media content produced by the user, and
a media consumption history of the user.

6. The computer-implemented method of claim 2, wherein the summarization includes withholding advanced topics and summarizing the advanced topics for learners below a predetermined level,
wherein the expansion, for a concept classified as advanced, expands the concept by searching a database and adding extra learning material to explain the concept, and
wherein the simplification, for a user with a language capability less than a threshold value, modifies the content by changing the language in the content to simpler language modified to be presented using simpler language.

7. The computer-implemented method of claim 1, wherein the corpus of the content comprises a single corpus.

8. The computer-implemented method of claim 1, wherein the corpus of the content includes only one version of the content.

9. The computer-implemented method of claim 1, wherein the modifying changes words of one version of the content to provide a different version that is understandable by the user based on the baseline of the user.

10. The computer-implemented method of claim 1, embodied in a cloud-computing environment.

11. A computer program product for textual content adaption, the computer program product comprising a computer-readable storage medium having program instructions embodied therewith, the program instructions executable by a computer to cause the computer to perform:
receiving a corpus of content;
segmenting the content into sections;
determining a classification for each section by determining an audience and an expertise level for the section;
determining a baseline for a user;
modifying a portion of the content from the corpus based on the classification of the sections included in the portion of the content and based on the baseline of the user, and
providing the modified portion of the content to the user.

12. The computer program product of claim 1, wherein the modifying modifies the portion of the content by one of:
summarization;
expansion;
simplification; and
a substitution of a first section for a second section.

13. The computer program product of claim 11, wherein the baseline of the user is continually adjusted based on changes to the baseline for the user and on user feedback indicating an understanding of the content.

14. The computer program product of claim 11, wherein the baseline of the user is based on at least one of:
an education of the user;
a demographic of the user;
social media content produced by the user, and
a media consumption history of the user.

15. The computer program product of claim 11, wherein the baseline of the user is based on a combination of each of:
an education of the user;
a demographic of the user;
social media content produced by the user; and
a media consumption history of the user.
determining a baseline for a user;
modifying a portion of the content from the corpus based on the classification of the sections included in the portion of the content and based on the baseline of the user, and
providing the modified portion of the content to the user.

20. The system of claim 19, embodied in a cloud-computing environment.
